(19) United States
(12) Patent Application Publication
(10) Pub. No.: US 2007/0069039 A1
(43) Pub. Date: Mar. 29, 2007

(54) Christmas tree alarm system

(76) Inventors: John DeCosmo, Glenview, IL (US); Kenneth W. Pabst, Northbrook, IL (US); Brian M. Gleason, Des Plaines, IL (US); Howard L. Frank, Skokie, IL (US); Bernard J. Gershen, Centerport, NY (US)

Correspondence Address: Stephen G. Rudisill;JENKENS & GILCHRIST, A PROFESSIONAL CORPORATION, Ste. 2600, 225 W. Washington, Chicago, IL, 60606-3418, US

(21) Appl. No.: 11/484,110

(22) Filed: Jul. 11, 2006

Related U.S. Application Data
(60) Provisional application No. 60/699,004, filed on Jul. 13, 2005.

(51) Int. Cl. G05D 23/12

(52) U.S. Cl. 236/100

(57) ABSTRACT

An alarm system for an indoor Christmas tree comprises a temperature sensor located on the tree or in proximity to the tree, an excessive-temperature detection circuit connected to the sensor and producing an excessive-temperature output signal when the sensed temperature exceeds a predetermined limit, and an alarm receiving the excessive-temperature output signal and producing an alarm indicating that the predetermined temperature limit has been exceeded. The excessive-temperature detection circuit and the alarm are located remotely from the tree, are powered by a standard power distribution system of the building in which the tree is located, and are connected to the temperature sensor at the tree by wires. An alarm may also be produced in response to an open circuit or a short circuit in the wires connecting the excessive-temperature detection circuit to the temperature sensor. The excessive-temperature detection circuit is housed in the plug that connects the alarm system to the power distribution system, and the temperature sensor is contained in a tree ornament in one embodiment.

### CROSS-REFERENCE TO RELATED APPLICATIONS

This application claims priority to U.S. Provisional Application Ser. No. 60/699,004 filed Jul. 13, 2005.

### FIELD OF THE INVENTION

The present invention relates generally to safety alarm systems for detecting high temperature conditions, such as caused by the burning of a Christmas tree inside a residence or other building.

### SUMMARY OF THE INVENTION

In accordance with one embodiment of the present invention, there is provided an alarm system for an indoor Christmas tree comprising a temperature sensor located on the tree or in proximity to the tree, an excessive-temperature detection circuit connected to the sensor and producing an excessive-temperature output signal when the sensed temperature exceeds a predetermined limit, and an alarm receiving the excessive-temperature output signal and producing an alarm indicating that the predetermined temperature limit has been exceeded.

In one embodiment, the excessive-temperature detection circuit and the alarm are located remotely from the tree, are powered by a standard power distribution system of the building in which the tree is located, and are connected to the temperature sensor at the tree by wires. An alarm is preferably also produced in response to an open circuit or a short circuit in the wires connecting the excessive-temperature detection circuit to the temperature sensor. The excessive-temperature detection circuit is preferably housed in the plug that connects the alarm system to the power distribution system.

The temperature sensor is contained in a tree ornament in one embodiment.

One particular embodiment includes a probe that can be immersed in a vessel containing water at the base of the tree and is connected to a low-water detection circuit that produces a low-water output signal when the probe is not in contact with water. The low-water detection circuit can be supplied with power from the same source that supplies the excessive-temperature detection circuit and its alarm.

### BRIEF DESCRIPTION OF THE DRAWINGS

FIG. 1 is a diagram of one embodiment of an alarm system embodying the invention, for use with an indoor Christmas tree;

FIG. 2 is a schematic diagram of a portion of the electrical circuitry included in the alarm system of FIG. 1 for generating an alarm signal in response to an excessive temperature in the vicinity of the tree;

FIG. 3 is the resistance v. temperature characteristic of a thermistor that is suitable for use in the circuit of FIG. 2;

FIG. 4 is a schematic diagram of another portion of the electrical circuitry included in the alarm system of FIG. 1 for generating a signal in response to a low-water condition at the base of the tree; and

FIG. 5 is a schematic diagram of a power supply circuit included in the alarm system of FIG. 1.

### DETAILED DESCRIPTION OF ILLUSTRATED EMBODIMENT

Although the invention will be described in connection with a certain preferred embodiment, it will be understood that the invention is not limited to that particular embodiment. On the contrary, the invention is intended to cover all alternatives, modifications, and equivalent arrangements as may be included within the spirit and scope of the invention as defined by the appended claims.

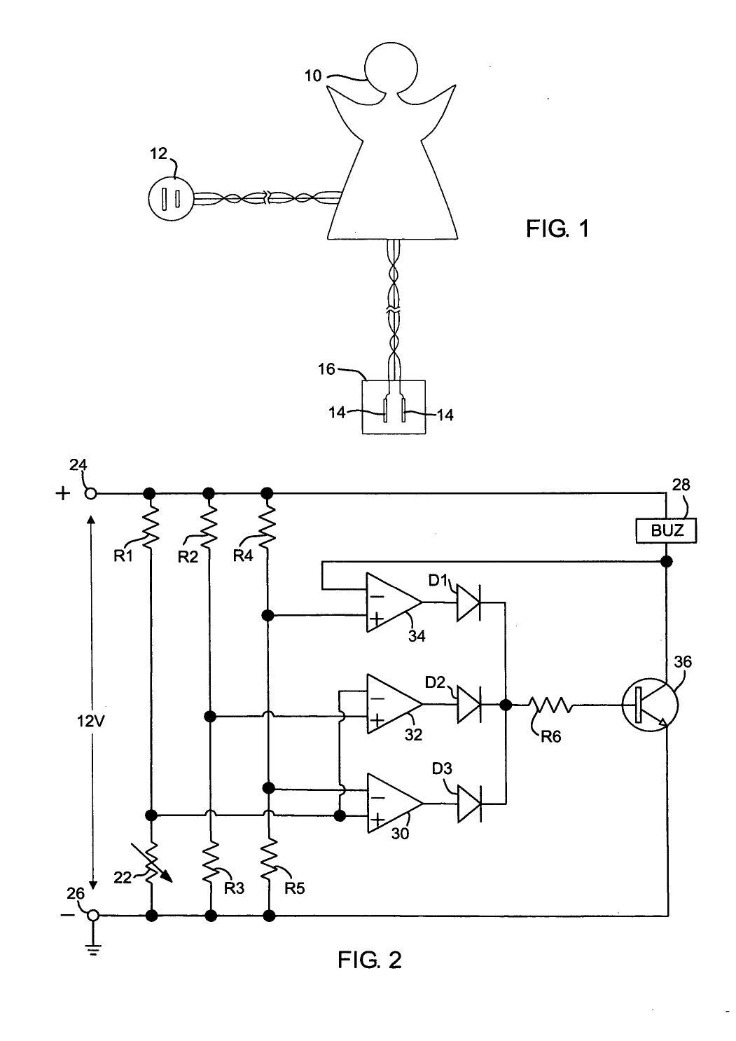

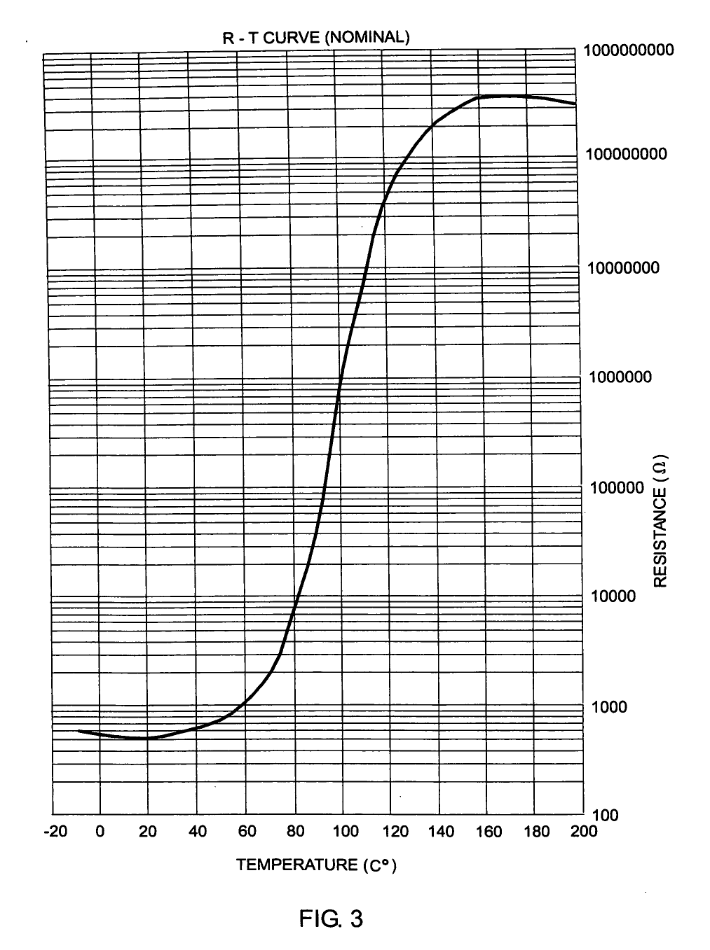

Turning now to the drawings, FIG. 1 diagrammatically illustrates an alarm system for use with an indoor Christmas tree (not shown) having an ornament 10 attached to an upper portion of the tree, and having the base of its trunk immersed in water in a suitable vessel. The ornament 10 contains electrical circuitry that is powered from a wall plug 12 (preferably with polarized blades) and connected to a pair of probes 14 in a housing 16 that is immersed in, and open to, the same body of water in which the base of the tree trunk is immersed.

FIG. 2 illustrates a temperature-detection and alarm circuit 20 that is preferably housed in the plug 12, except for a temperature-sensing thermistor 22 that is located in the ornament 10. Because only the thermistor 22 is located in the ornament attached to the tree, and all the other electronic components, including the alarm device to be described below, are located remotely from the tree, an activated alarm will remain activated even when a fire damages the thermistor 22 and/or the leads connecting the thermistor to the circuitry housed in the plug 12. An activated alarm will also remain activated when an open circuit or short circuit occurs in the leads to the thermistor 22, as might be caused by a fire, foot traffic, a dog chewing on the leads, or any other cause.

Still referring to FIG. 2, a pair of terminals 24 and 26 receive 12-volt d-c. power from a power supply circuit, which is also contained in the plug 12 and is described in detail below. The circuit 20 activates an alarm 28 whenever (1) the power supplied to the terminals 24, 26 is interrupted or (2) the resistance of the thermistor 22 corresponds to a preselected temperature rise, indicating an excessive temperature rise in the region of the ornament 10.

The circuit 20 uses three operational amplifiers 30, 32 and 34 to control a transistor 36, which in turn controls the energization of the alarm 28. The transistor 30 and the alarm 28 are connected in series with each, across the terminals 24 and 26. The non-inverting inputs of the three operational amplifiers 30-34 are connected to the midpoints of three parallel voltage dividers formed by (1) a resistor R1 and the thermistor 22, (2) resistors R2 and R3, and (3) resistors R4 and R5, respectively. The inverting inputs of the operational amplifiers 30-34 are connected to (1) the midpoint of the voltage divider formed by resistors R4 and R5, (2) the midpoint of the voltage divider formed by the resistors R1 and the thermistor 22, and (3) the line connecting the alarm 28 and the transistor 36, respectively.

The outputs of the operational amplifiers 30-34 are connected via respective diodes D1-D3 and a resistor R6 to the base of the transistor 36, so that a high output from any of the amplifiers 30-34 will turn on the transistor 36 and thereby energize the alarm 28. As will be discussed in more detail below, a high output is produced (1) at the output of the operational amplifier 30 in response to an excessive temperature at the ornament 10, to activate the alarm 28, (2) at the output of the operational amplifier 32 in response to a short circuit between the wires connecting the circuit 20 to the thermistor 22, to activate the alarm 28, and (3) at the output of the operational amplifier 34 in response to conduction of the transistor 36, to latch the transistor “on.”. In either case, the transistor 36 is turned on to activate the alarm 28.

The thermistor 22 preferably has a positive-temperature-coefficient, and the resistance/temperature characteristic of one such thermistor is illustrated in FIG. 2. It can be seen that the minimum resistance is about 500 ohms at about 20° C. At a temperature of about 72° C., the resistance of the thermistor 22 is about 2.4 kohms. If the resistor R1 has a value of 2.4 kohms, the voltage at the midpoint of the divider formed by R1 and the thermistor 22, and thus at the non-inverting input of the operational amplifier 30, at 72° C. is half the supply voltage of 12 volts, or 6 volts. The voltage at the inverting input of the operational amplifier 30 will also be at half the supply voltage if the two resistors R4 and R5 have equal values (e.g., two 10-kohm resistors). Thus, as long as the resistance of the thermistor 22 is less than 2.4 kohms (i.e., the temperature of the thermistor 22 is below 72° C.), the output of the operational amplifier 30 remains low. When the resistance of the thermistor 22 goes above 2.4 kohms (i.e., the temperature of the thermistor goes above 72° C.) the output of the operational amplifier 30 goes high, thereby producing an excessive-temperature output signal that turns on the transistor 36 to energize the excessive-temperature alarm 28.

The operational amplifier 32 has its inverting input connected to the divider formed by the resistor R1 and the thermistor 22, while its non-inverting input is connected to the midpoint of the voltage divider formed by resistors R2 and R3. When the thermistor 22 is at its minimum resistance of 500 ohms, and the resistor R1 is 2.4 kohms, the minimum voltage at the inverting input of the operational amplifier 32 is 2 volts. The voltage at the midpoint of the R2, R3 divider for the non-inverting input of amplifier 32 is set at 1 volt by using a resistor R2 that has a much higher value than resistor R3. Therefore, the output of the operational amplifier 32 should never go high, unless the wires connecting the thermistor 22 to the circuit 20 are short-circuited. In the event of such a short circuit, the inverting input goes essentially to ground, below the 1-volt on the non-inverting input, and thus the output of the operational amplifier 32 goes high. This turns on the transistor 36 to energize the alarm 28.

An open circuit in the wires connecting the thermistor 22 to the circuit 20 will also activate the alarm 28 because such an open circuit has the same effect that a very high temperature has on the thermistor 22, i.e., the resistance of the thermistor 22 goes very high, approaching an open circuit. This causes the output of the operational amplifier 30 to go high, turning on the transistor 36 to activate the alarm 28.

The third operational amplifier 34 serves as a latch. Its non-inverting input is connected to the midpoint of the R4, R5 divider, which is at 6 volts, and its inverting input is connected to the collector of the transistor 36. As long as the alarm 28 is not energized, the collector voltage is at 12 volts, and thus the output of the operational amplifier 34 is low. When the alarm 28 is energized, the voltage applied to the inverting input of the operational amplifier 34 drops below 6 volts, and thus the amplifier 34 supplies a high voltage to the base of the transistor 36. Even if the outputs of both the operational amplifiers 30 and 32 go low, the output of the operational amplifier 32 remains high, thereby keeping the transistor 36 on and keeping the alarm 28 energized. The alarm remains on until the power supply is removed.

It will be understood that the operational amplifiers 30-34 are used as comparators in the circuit 20, with the gain set as high as possible. The three diodes D1-D3 connected to the outputs of the three operational amplifiers 30-34 make the amplifiers function as OR circuits so any of the amplifier outputs going low will not interfere with any of the amplifiers going high. A resistor R6 in series with the base of the transistor 36 limits the base current.

It is possible to vary the trigger temperature by varying the divider resistors connected to the operational amplifier 30. Drive current for the transistor 36 can be varied by adjusting the value of the resistor R6.

A modified version of the system described above couples the thermistor 22 in the ornament 10 to the circuitry in the plug 12 wirelessly, such as by the use of a conventional Bluetooth transmitter and receiver.

The temperature detection and alarm system described above may also be used in other applications, such as for monitoring the temperature in a hood over a stove, in the vicinity of a heating furnace or a hot water heater, or in the vicinity of a fireplace.

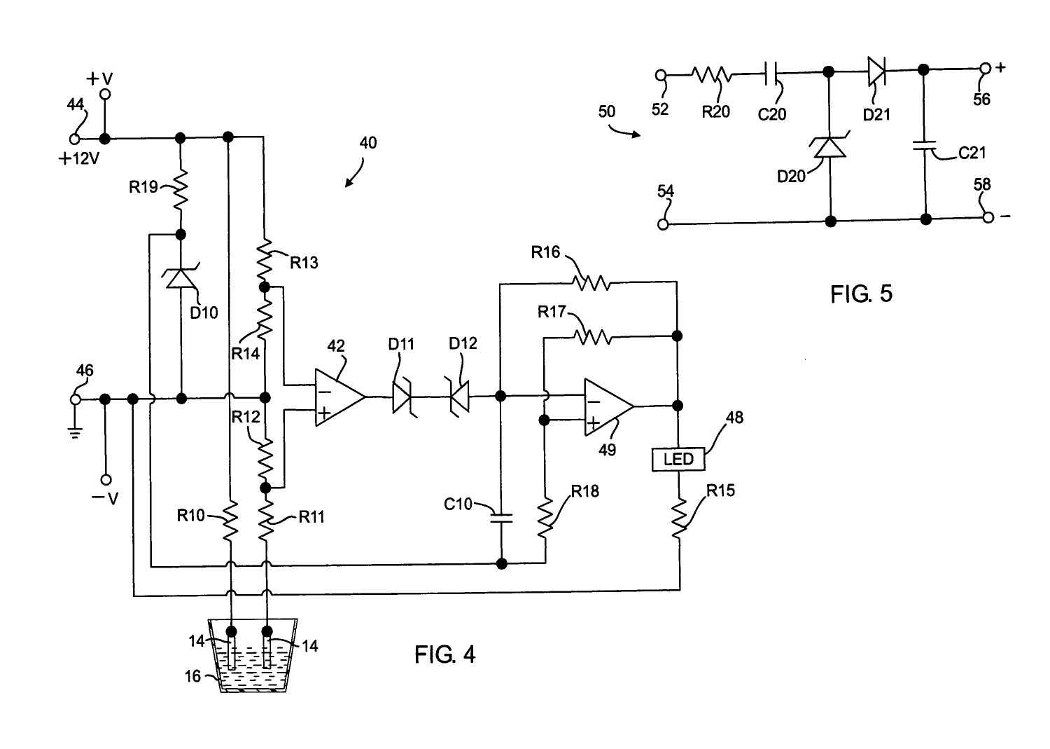

FIG. 4 is a schematic diagram of a water-level detection circuit 40, which is preferably housed in the ornament 10. For safety reasons, the circuit 40 limits the maximum current that can flow from the probes 14 (or the water in which the probes are immersed) to a grounded person to 0.5 milliamperes (mA). This current limit is effected by a pair of 240-kohm resistors R10 and R11 connected in series with each of two wires connecting the circuit 40 to the leads of the detector probes 14 immersed in the water in vessel 16. Thus, the maximum current that can flow at 12 volts is 12/480,000=0.025 mA, or 25 microamperes. In addition, another 240,000-ohm resistor R12 is connected between ground and the non-inverting input of an operational amplifier 42, which further reduces the maximum current that can flow to 166 microamperes (12/(480,000+240,000)=0.0166 mA, or 16.6 microamperes). The resistance of the water is normally less than that provided by this circuit.

An alternative to the use of the large resistors is to use a step-down transformer to provide the 12-volt supply from the standard 110-volt power line. The transformer isolates the probes P from the 110-volt power line without the large resistors R10 and R11, thereby protecting against improper wiring in a building, or improper (reversed) connections at a power-line receptacle.

An operational amplifier 42 has its non-inverting input connected to the junction of resistors R11 and R12, and its inverting input to the junction of a pair of resistors R13 and R14 connected across a pair of terminals 44 and 46 that receive 12-volt d-c. power from the power supply circuit. When the probes 14 are out of the water, there is no connection between the probes, and no current can flow. Therefore, no voltage appears at the non-inverting input of the operational amplifier 42. The inverting input of the operational amplifier 42 is connected to the midpoint of a voltage divider formed by resistors R13 and R14 connected between the +12-volt terminal 44 and ground. Suitable values for the resistors R13 and R14 are 120 kohms and 1 kohm, respectively, which provides a voltage of +0.1 volt at the inverting input of the operational amplifier 42. Since the voltage at the inverting input is positive as compared to the voltage at the non-inverting input, the output of the operational amplifier 42 is high, at approximately +12 volts.

When the probes 14 are immersed in the water, and assuming that the water's resistance is small compared to 240 kohms, the voltage across each of the three 240-kohm resistors R10-R12 is ⅓ of the available 12 volts, or 4 volts. This is the non-inverting input to the operational amplifier 42, which is more positive than the 0.1 volt at the inverting input. Thus the output of the operational amplifier 42 is driven close to ground potential.

The change of state of the output of the operational amplifier 42 is used to repetitively energize and de-energize an LED 48, as described in more detail below. The component values in the circuit 40 are adjusted to provide a flashing rate of 0.5 second “on” to 5 seconds “off” for the LED 48. If the current is much greater than the 20 mA that the power supply can provide, it can recover during the 5 seconds that the LED 48 is turned “off.” The LED 44 is connected in series with a resistor R15 whose value is determined by the current requirements of the LED, and by whether multiple LED's are connected in series.

When power is first applied to the circuit 40, a capacitor C10 is initially discharged, and thus the voltage at the inverting input of a second operational amplifier 49 is floating, but close to +6.2 volts. The output of the operational amplifier 49 is a voltage of either +12 volts or 0 volts (ground), which is coupled to the inverting and non-inverting inputs of the amplifier 49 through resistors R16 and R17, respectively. Assuming that the initial output voltage of the amplifier 49 is +12 volts, the voltage at the non-inverting input is at 6.2 volts +0.62 volts. The capacitor C10 begins to charge positively through a resistor R16 until the voltage at the inverting input exceeds 6.2+0.62 volts. At this time, the output will drop to 0 volts, and the non-inverting input voltage will be 6.2 volts−0.62 volts. The capacitor C10 now discharges through the resistor R16 until its voltage drops below the voltage at the non-inverting input, and the process will repeat itself. The circuit 40 will oscillate at a half time “on” and half time “off.”

The operational amplifiers 42 and 49 are preferably contained in a single integrated circuit, such as a 741 with two operational amplifiers in the same package. This integrated circuit requires both positive and negative power supplies, which are simulated by using a single positive power supply and generating a false mid point (ground) by connecting a 62-kohm resistor R19 in series with a 6.2-volt zener diode D10 across the power input terminals 44 and 46. The false ground is at the junction of the resistor R19 and the zener diode D10. The positive power inputs of the operational amplifiers 42 and 49 are connected to +12 volts at +V, and their negative power inputs are connected to neutral (ground) at −V.

The output of the operational amplifier 42 is connected to the LED oscillator section via two back-to-back zener diodes D11 and D12. It will be recalled that when the probes 14 are in water, the output of the operational amplifier 42 is at +12 volts. The other side of the zener diodes D11, D12 is connected to the inverting input of the operational amplifier 49, and is at about +7 volts. The highest voltage that the non-inverting input can reach is 6.2 volts +0.62 volts, which is lower than the 7 volts at the inverting input. Therefore, the output of the amplifier 49 will go low, and will be held there, i.e., the oscillator will be dormant and the output will be low, so it does not draw any current.

When the probes 14 are not immersed in water (e.g., the water has not been consumed by the tree and not replenished), the output of the operational amplifier 42 goes to ground (zero) volts, and there is not enough voltage to break down the zener diodes D11 and D12. Therefore, the oscillator begins flashing the LED 44.

FIG. 5 is a schematic diagram of a power supply circuit 50 that is preferably housed in the plug 12, for converting the standard 120-volt a-c. power to 12-volt d-c. power for the circuits described above. The plug 12 is preferably polarized to ensure (for a properly wired building) that the grounded conductor (neutral) will be identified. Thus, the water level detector will not energize the water to the line voltage of 120 volts.

A positive input terminal 52 is connected to the hot, ungrounded conductor of the standard power line, in series with a 240-ohm, 1-watt resistor R20 and a 1.0-ufd, 400-volt capacitor C20. The reactance of the capacitor is 1652 ohms, and the RMS current for the series circuit at 120 volts is 40 mA. The resistor R20 is used to limit the worst case peak current that could flow upon energization of an uncharged capacitor, or one that is charged to the peak of 120 volts (169 volts) when the power is removed and then re-introduced before the capacitor can discharge, and in the opposite polarity. The result would be re-charging of the capacitor C20 from an equivalent 338-volt source. The resistor R20 preferably limits the surge current to 1.4 amperes.

When the input to the circuit 50 is negative 120 volts, the charging current for the capacitor C20 flows through a 12-volt, 1-watt zener diode D20 in its forward direction, which limits the voltage to the forward voltage drop of the zener, or about 0.7 volts. When the input to the circuit 50 is positive 120 volts, the zener diode D20 breaks down at 12 volts. The result is that the capacitor C20 has a bi-directional current, and the output is half wave limited to 12 volts.

A conventional diode D21 (e.g., IN4004) is connected between the positive output terminal 56 and the junction of the cathode of the zener diode D20 and the capacitor C20. The diode D21 rectifies the voltage, and only permits the positive 11-volt half wave to appear at the positive terminal of a 1000-ufd, 16-volt electrolytic capacitor C21 which acts as a filter. The 0.7-volt forward voltage drop in the diode D21 reduces the 12-volt zener output to 11 volts at the filter capacitor C21. The capacitor C21 filters the half wave produced, and this is the 12-volt d-c. output of the power supply circuit 50. Since the filter receives a half wave voltage, the output current available is only approximately 20 mA.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. An alarm system for an indoor Christmas tree comprising
a temperature sensor located on said tree or in proximity to said tree,
a temperature detection circuit connected to said sensor and producing an excessive-temperature output signal when the temperature sensed by said sensor exceeds a predetermined limit, and
an alarm receiving said excessive-temperature output signal and producing an alarm indicating that said predetermined temperature limit has been exceeded.

2. The alarm system of claim 1 wherein said excessive-temperature detection circuit and said alarm are located remotely from said tree and are connected to said temperature sensor by wires.

3. The alarm system of claim 2 wherein said alarm also produces an alarm in response to an open circuit or a short circuit in the wires connecting said excessive-temperature detection circuit to said temperature sensor.

4. The alarm system of claim 1 wherein said Christmas tree is located in a building having a standard power distribution circuit, and said excessive-temperature detection circuit and said alarm are powered by said standard power distribution circuit.

5. The alarm system of claim 4 which includes a plug for connecting said system to said standard power distribution system, said excessive-temperature detection circuit is housed within said plug, and said plug is located remotely from said tree and is connected to said temperature sensor by wires.

6. The alarm system of claim 1 which includes a tree ornament containing said temperature sensor.

7. The alarm system of claim 1 which includes a probe that can be immersed in a vessel containing water at the base of said tree and producing a second output signal indicating whether said probe is in contact with water, and a second detection circuit receiving said second output signal and producing a low-water alarm signal when said second output signal indicates that said probe is not in contact with water.

8. The alarm system of claim 7 which includes a tree ornament containing said second detection circuit.

9. The alarm system of claim 1 wherein said temperature sensor is a thermistor.
